(19) United States
(12) Patent Application Publication
(10) Pub. No.: US 2023/0204091 A1
(43) Pub. Date: Jun. 29, 2023

(54) ADDITIVE-COATED SHEAVE, METHOD OF MANUFACTURING THE SAME, AND METHODS OF REDUCING SOUND PRODUCED BY EQUIPMENT

(71) Applicant: Sherman + Reilly, Inc., Chattanooga, TN (US)

(72) Inventors: Harby Carter Hollis, Chattanooga, TN (US); Douglas Bruce MacDonald, Chattanooga, TN (US); John Jeremiah Morton, Chattanooga, TN (US)

(21) Appl. No.: 17/926,788

(22) PCT Filed: May 21, 2021
(86) PCT No.: PCT/US21/33627

§ 371 Date: Nov. 21, 2022

Related U.S. Application Data
(60) Provisional application No. 63/028,410, filed on May 21, 2020.

(51) Int. Cl. F16H 55/36; H02G 1/04; B33Y 80/00; B33Y 40/10; B33Y 40/20; B29C 64/30; B29C 64/35; B22F 10/14; B22F 10/28; B22F 10/68; B22F 10/64; B22F 10/66

(52) U.S. Cl. CPC F16H 55/36; H02G 1/04; B33Y 80/00; B33Y 40/10; B33Y 40/20; B29C 64/30; B29C 64/35; B22F 10/14; B22F 10/28; B22F 10/68; B22F 10/64; B22F 10/66; B66B 15/02

(57) ABSTRACT

An additive-coated sheave assembly having a wheel with a groove in an outer circumferential surface of the wheel. The additive-coated sheave assembly can have an axle configured to support the wheel and a frame configured to receive and support the axle. A coating can be affixed to the groove by an additive manufacturing process. A method of manufacturing a sheave by coating the groove with a coating by an additive manufacturing process is also disclosed.

### CROSS-REFERENCE TO RELATED APPLICATIONS

This application claims benefit under 35 USC § 119(e) of U.S. Provisional Patent Application No. 63/028,410 filed 21 May 2020, the entirety of which is incorporated herein by reference as if set forth herein in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The disclosed technology relates generally to coated sheaves; and, more specifically, to coated sheaves that are manufactured by using an additive manufacturing process.

### 2. Description of Related Art

Sheaves, or grooved pulleys, are used in numerous applications. Sheaves are commonly used by electric utility workers, for example, when stringing transmission line conductors, wires, ropes, and cables (collectively, “cables”) on power poles. A sheave typically comprises a wheel on an axle supported by a frame with the wheel able to spin on the axle when a force is applied. Because the wheel can spin, the sheave reduces friction and transfers the force along the cable as it is pulled through the sheave and over the crossarm of a power pole. The sheave also protects the cable from damage that may occur if the cable is dragged into position, for example, instead of rolling across the sheaves. This is particularly important because any damage to the cable can reduce the life of the cable, increase overall costs, and weaken the cable potentially creating a dangerous situation if the cable were to break.

The sheaves are generally made of high strength material, including metals and high-strength polymers, capable of withstanding the forces applied while in use. Ideally, sheaves used in the electric utility industry are made of material having a high strength-to-weight ratio enabling the sheave to withstand the forces applied, while making the sheave lighter and easier to install. Sheaves include a groove on the wheel shaped such that the cable can rest inside the groove. The groove provides greater control of the cable while in use by guiding the cable toward the center of the groove to ensure the cable does not slip off the wheel. The groove also serves to protect the cable from rubbing on the wheel, the sheave frame, or the power pole. Current sheave designs utilize polished surfaces and sometimes coatings in the groove to provide further protection for the conductor. A smooth and ductile surface inside the groove reduces abrasion and further ensures the sheave does not damage the cable.

Currently, the most common methods of coating the groove with a protective material include low-pressure injection molding or bolting the liner onto the sheave. Low-pressure injection molding involves placing the sheave in a mold and inserting a molten material into the mold to bond with the sheave. Unfortunately, this process involves high up-front tooling costs, large lead times, and the coating can harden unevenly resulting in material weaknesses. Furthermore, it can be difficult and expensive to make changes to the molds when deficiencies are discovered. Bolting the liner onto the wheel also has its drawbacks because a loose bolt, or loose portion of the liner, can damage the cable. These and other problems are addressed by embodiments of the technology disclosed herein.

### SUMMARY

The disclosed technology relates generally to coated sheaves; and, more particularly, to coated sheaves that are manufactured by using an additive manufacturing process. The disclosed technology can include an additive-coated sheave assembly comprising a wheel having a groove in an outer circumferential surface of the wheel. The additive-coated sheave assembly can include an axle configured to support the wheel. The additive-coated sheave assembly can include a frame configured to receive and support the axle. The wheel of the additive-coated sheave assembly can include a coating that can be affixed to the groove by an additive manufacturing process.

Implementations of the disclosed technology can include one or more of the following features. The additive manufacturing process can include repeatedly spraying the coating onto the groove, repeatedly dipping the wheel into a molten material and allowing the material to harden between each dip, photopolymerization, powder bed fusion, binder jetting, material extrusion, ultrasonic additive manufacturing, directed energy deposition, and/or electron beam melting.

The groove can be pretreated with a primer before the coating is affixed to the groove. The groove can be sanded before the coating is affixed to the groove. The groove can be heat treated before the coating is affixed to the groove. The groove can be pretreated with a corona treatment before the coating is affixed to the groove. The groove can be pretreated with a plasma treatment before the coating is affixed to the groove. One or more depressions can be formed into the groove before the coating is affixed to the groove. One or more ridges can be formed into the groove before the coating is affixed to the groove. An adhesive can be used to affix the coating to the groove.

The coating can include a monomer material, a polymer material, a composite material, a metal, and/or a ceramic material. The coating can include a smooth exterior surface or a textured exterior surface. The coating can include one or more ridges. The coating can include a material that is harder than a material of the wheel. Alternatively, or in addition, the coating can include a material that is softer than a material of the wheel. The coating can include two or more materials affixed to the groove in alternating transverse bands. The additive-coated sheave assembly can include a bearing or a bushing positioned between the wheel and the axle. The groove can be cut into the outer circumferential surface of the wheel.

The wheel can include a single continuous material. Alternatively, the wheel can include: a hub; a plurality of spokes affixed to the hub; and a rim. The outer circumferential surface of the rim can include the groove. The wheel can include a two or more materials.

The groove can be forged into the outer circumferential surface of the wheel and/or cut into the outer circumferential surface of the wheel.

The disclosed technology can include a method of manufacturing an additive-coated sheave. The method can include providing a wheel, forming a groove into an outer circumferential surface of the wheel, and coating the groove with a material by an additive manufacturing process. The additive manufacturing process can include repeatedly spraying the coating onto the groove, repeatedly dipping the wheel into a molten material and allowing the material to harden between each dip, photopolymerization, powder bed fusion, binder jetting, material extrusion, ultrasonic additive manufacturing, directed energy deposition, and/or electron beam melting.

The method can include treating an outer surface of the groove prior to coating the groove with the material by the additive manufacturing process. Treating the outer surface of the groove can include pretreating the outer surface of the groove with a primer, sanding the outer surface of the groove, heat treating the outer surface of the groove, pretreating the outer surface of the groove with a corona treatment, pretreating the outer surface of the groove with a plasma treatment, forming one or more depressions into the outer surface of the groove, forming one or more ridges on the outer surface of the groove, and/or applying an adhesive to the outer surface of the groove.

The method can include finishing the coating of the groove using a post-manufacturing process. The post-manufacturing process can include machining the groove, routing the groove, applying a heat treatment to the coating, applying an ultra-violet treatment to the coating, curing the coating, cleaning the coating, de-powdering the coating, sanding the coating, sand blasting the coating, shot peening the coating, dying the coating, and/or painting the coating.

The disclosed technology can include a method of manufacturing an additive-coated sheave. The method of manufacturing can include providing an aluminum wheel, forming a groove into an outer circumferential surface of the aluminum wheel, sanding the groove, and coating the groove with a material by an additive manufacturing process. The additive manufacturing process can include repeatedly dipping the additive-coated sheave into a molten material and allowing the molten material to harden between each dip of the additive-coated sheave into the molten material.

The disclosed technology can include a method of manufacturing an additive-coated sheave. The method of manufacturing can also include providing a nylon wheel, forming a groove into an outer circumferential surface of the nylon wheel, treating the groove with a plasma treatment, and coating the groove with a material by an additive manufacturing process. The additive manufacturing process can include repeatedly spraying a liquid material onto the additive-coated sheave and allowing the liquid material to harden between each spray of the liquid material onto the additive-coated sheave.

The disclosed technology can include a method of manufacturing an additive-coated sheave. The method of manufacturing can also include providing a stainless steel wheel, forming a groove into an outer circumferential surface of the stainless steel wheel, treating the groove by etching depressions into an outer surface of the groove, and coating the groove with a material by an additive manufacturing process. The additive manufacturing process can include material extrusion.

As will be appreciated by one of skill in the art, the various features and method steps described herein can be varied with the various manufacturing processes and materials described herein. For example, an additive-coated sheave can be manufactured with the groove being pretreated with any of the pretreatments described herein and the coating being applied to the groove with any of the additive-manufacturing processes described herein.

Additional features, functionalities, and applications of the disclosed technology are discussed herein in more detail.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner.

FIG. 1 is a perspective view of an additive-coated sheave, in accordance with the disclosed technology

FIG. 2 is a side view of an additive-coated sheave assembly, in accordance with the disclosed technology.

FIG. 3 is a flowchart depicting an example of a method for manufacturing an additive-coated sheave, in accordance with some examples of the present disclosure.

FIG. 4 illustrates a system for reducing sound and vibrations produced by equipment, in accordance with the disclosed technology.

### DETAILED DESCRIPTION

Examples of the present disclosure relate to a sheave that is coated with a protective coating by an additive manufacturing process. The sheave can comprise a pulley with a groove sized and shaped to accept conductors, wires, ropes, and cables (collectively, “cables”). The groove can be coated, using a suitable additive manufacturing process, in a material that can be different than the material of the pulley. A metal pulley can be coated in a polymer or rubber, for example, to improve the grip between the sheave and the cable, while reducing or eliminating damage caused by the sheave to the cable. The coating can be applied by an additive manufacturing process to address the shortcomings of existing manufacturing methods, some of which are discussed above.

To facilitate an understanding of the principles and features of the disclosed technology, various illustrative examples are explained below. In particular, the presently disclosed subject matter is described in the context of being a coated sheave used in the electric utility industry. Examples of the present disclosure, however, are not limited to the electric utility industry and can be applicable in other contexts. Other applications can include, for example, nautical or maritime applications, general construction, industrial manufacturing, mining, ski lifts, automotive applications, arborist and logging applications, elevators, and any other industry or application which commonly uses sheaves. These examples are contemplated within the scope of the present disclosure. Accordingly, when the present disclosure is described in the context of an electric utility, it will be understood that other examples can take the place of those referred to.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. In other words, the terms “a,” “an,” and “the” do not denote a limitation of quantity, but rather denote the presence of “at least one” of the referenced item.

As used herein, the term “and/or” may mean “and,” it may mean “or,” it may mean “exclusive-or,” it may mean “one,” it may mean “some, but not all,” it may mean “neither,” and/or it may mean “both.” The term “or” is intended to mean an inclusive “or.”

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose. It is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value. Further, the term “about” means within an acceptable error range for the particular value as determined by one of ordinary skill in the art, which will depend in part on how the value is measured or determined, i.e., the limitations of the measurement system. For example, “about” can mean within an acceptable standard deviation, per the practice in the art. Alternatively, “about” can mean a range of up to ±20%, preferably up to ±10%, more preferably up to ±5%, and more preferably still up to ±1% of a given value. Alternatively, the term can mean within an order of magnitude, preferably within 2-fold, of a value. Where particular values are described in the application and claims, unless otherwise stated, the term “about” is implicit and in this context means within an acceptable error range for the particular value.

Throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

Throughout this description, various components may be identified having specific values or parameters, however, these items are provided as exemplary embodiments. Indeed, the exemplary embodiments do not limit the various aspects and concepts of the present disclosure as many comparable parameters, sizes, ranges, and/or values may be implemented. The terms “first,” “second,” and the like, “primary,” “secondary,” and the like, do not denote an order, quantity, or importance, but rather are used to distinguish one element from another.

It is noted that terms like “specifically,” “preferably,” “typically,” “generally,” and “often” are not utilized herein to limit the scope of the claimed disclosure or to imply that certain features are critical, essential, or even important to the structure or function of the claimed disclosure. Rather, these terms are merely intended to highlight alternative or additional features that may or may not be utilized in a particular embodiment of the present disclosure. It is also noted that terms like “substantially” and “about” are utilized herein to represent the inherent degree of uncertainty that may be attributed to any quantitative comparison, value, measurement, or other representation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “50 mm” is intended to mean “about 50 mm.”

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described hereinafter as making up the various elements of the present disclosure are intended to be illustrative and not restrictive. Many suitable materials that would perform the same or a similar function as the materials described herein are intended to be embraced within the scope of the disclosure. Such other materials not described herein can include, but are not limited to, materials that are developed after the time of the development of the disclosure, for example. Any dimensions listed in the various drawings are for illustrative purposes only and are not intended to be limiting. Other dimensions and proportions are contemplated and intended to be included within the scope of the disclosure.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, similar components that are developed after development of the presently disclosed subject matter.

As used herein, the term “additive manufacturing” and its variants refer to various manufacturing processes wherein a component, or a portion of a component, is manufactured one layer at a time by adding a material layer-by-layer to form the component, or the portion of the component. Although various additive manufacturing processes are described herein, one of skill in the art will appreciate that various other additive manufacturing process, whether known or later developed, can take the place of those described herein.

Referring now to the drawings, in which like numerals represent like elements, example embodiments of the present disclosure are herein described.

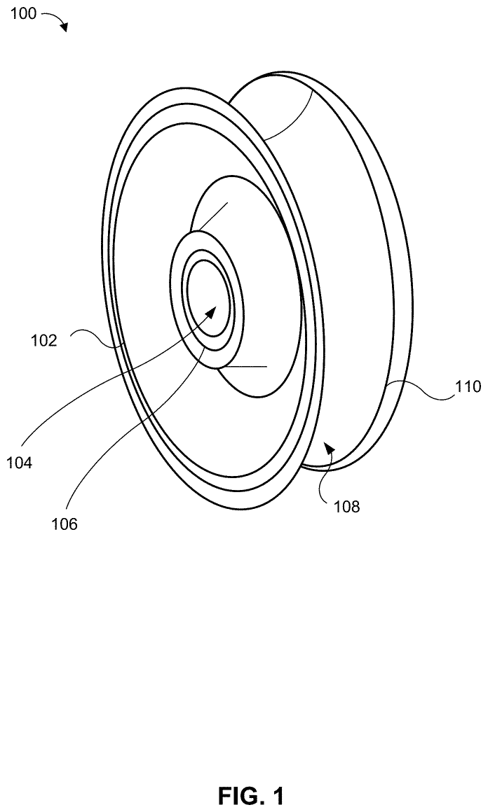

As shown in FIG. 1, the additive-coated sheave 100 can comprise a wheel 102, a center bore 104, a bearing 106 (shown, or a bushing), a groove 108, and a coating 110. The additive-coated sheave depicted in FIG. 1 is offered only for illustrative purposes and should not be construed to be limiting as to size, shape, design, or proportion. The diameter of the additive-coated sheave 100, for example, can vary in size from less than an inch for specialized manufacturing applications to larger than twenty feet for use in ski lift or other large applications. Furthermore, the additive-coated sheave 100 can be a bull wheel, a roller, a capstan, a pulley, or any other variation of a sheave. One of skill in the art will understand that the described additive-coated sheave 100 can be adapted to many different applications.

In some examples, the wheel 102 can be a solid piece of material as shown in FIG. 1. Alternatively, the wheel 102 can have spokes or be assembled with several pieces, such as a wheel 102 comprising a rim, hub, and spokes connecting the rim to the hub. The wheel 102 can be two pieces of stamped metal, each forming half of the wheel and being welded, riveted, bolted, glued, or mechanically bonded together to form the wheel 102. Regardless, the wheel 102 can support the cable when it passes over the additive-coated sheave 100.

The wheel 102 can be made of any material that can provide support to the cable as it passes over the wheel 102. The wheel 102 can be made of metals such as, for example, aluminum, carbon steel, stainless steel, wrought iron, magnesium, tungsten, copper, bronze, brass, titanium, cobalt, metal alloys, or any other metal or combination of metals appropriate for the application. The wheel 102 can also be made of polymer or monomer materials which have an appropriate strength-to-weight ratio for the application. The wheel 102 can be made of, for example, acetal, acrylic, acrylonitrile butadiene styrene, polystyrene, nylon, polyamide-imides, polybutylene terephthalate, polyether ether ketone, polycarbonate, urethane, or any other type of polymer or monomer material suitable for the application. Alternatively, the wheel 102 can be made of composite materials designed for the application such as, for example, carbon composites, glass composites, metal composites, or monomer or polymer composites. Furthermore, the wheel 102 can be manufactured using any method suitable for the material and application, including, but not limited to, forged, cast, spun, extruded, machined, sintered or compacted powder, or molded.

The wheel 102 can have a groove 108 formed or manufactured into the outer perimeter surface of the wheel 102. In some examples, the groove 108 can be formed along with the wheel 102, such as when the wheel 102 is cast or forged. Alternatively, the groove 108 can be manufactured into the outer perimeter of the wheel during post-manufacturing processes such as milling, routing, machining, sanding, shot peening, or any other suitable post-manufacturing process. The wheel 102 can be cast or forged, for example, and the groove 108 can be machined into the outer perimeter of the wheel 102 afterwards with a milling machine, router, or other suitable tool.

The groove 108 can be sized and shaped for a particular application. If the additive-coated sheave 100 is intended to be used in the electric utility industry, for example, the groove 108 can be sized to comply with the current IEEE 524 sizing standards. Alternatively, in applications where no particular standards are required, the groove 108 can simply be shaped to best fit the cable that is to be used.

The wheel can have a center bore 104 sized to receive an axle and bearings 106, or bushings, installed between the wheel 102 and the axle. The bearings 106 can be installed to reduce friction between the wheel 102 and the axle and to allow the sheave to rotate freely. The bearings 106 can be designed for the particular application. The bearings can be, for example, deep-groove ball bearings, self-aligning ball bearings, spherical roller bearings, cylindrical roller bearings, needle roller bearings or any other appropriate type of bearings for the application. Furthermore, the bearings can be made of metals, composites, ceramics, monomer or polymer materials, or any other material or combination of materials suitable for the application.

The additive-coated sheave 100 can have a coating 110 applied to the groove 108 of the wheel 102 using an additive manufacturing process. The coating 110 can cover the groove 108 and provide a protective surface for the cable to rest upon. In some examples, the outer surface of the coating 110 can be smooth and/or soft, for example, to help to protect the cable. Alternatively, the coating 110 can be formed with a texture layer to improve engagement with the cable. The coating 110, for example, can include one or more ridges, bumps, gaps, holes, protrusions, or other variations to the surface of the coating 110 to form a textured layer. As will be appreciated by one of skill in the art, the coating 110 can be formed with many variations to fit the particular application.

The coating 110 can provide a high wear-resistant surface to protect the wheel 102 and the cable from damage that can occur from the cable contacting the wheel 102. The hardness of the coating 110 can be varied depending on the particular application. When the coating 110 material is softer than the wheel 102 material, for example, the coating 110 can be used to reduce the wear the cable experiences when contacting a wheel 102 that is harder than the cable. On the other hand, when the coating 110 material is harder than the wheel 102 material the coating 110 can act as a wear-resistant surface to help extend the life of the wheel 102. Similarly, the coating 110 can have a higher or lower coefficient of friction than the wheel 102. As will be appreciated by one of skill of the art, an additional benefit of the coating 110 is that the coating 110 can help to reduce the noise produced by the cable passing over the additive-coated sheave 100. In other words, the coating 110 can act as a noise-reducing surface to reduce the overall noise produced when the additive-coated sheave 100 is in use.

Depending on the application, the characteristics of the coating 110 can be varied. When the wheel 102 is metal, the coating 110 can be a polymer or rubber compound, for example, that is softer than the wheel 102 and the cable. The coating 110 can be, for example and not limitation, a monomer or polymer such as nylon, urethane, epoxy, polyurethane, polyethylene, vinyl ester, or novolac epoxy. Alternatively, the coating 110 can include composite materials, ceramics, or metals. Furthermore, the coating 110 can comprise the same type of material as the wheel 102 where the coating 110 material properties can be varied to be softer or harder than the wheel 102. The wheel 102, for example, can be a nylon wheel and the coating 110 can be a coating of nylon which has been treated to be softer or harder than the nylon wheel 102. Furthermore, the coating 110 can comprise more than one material. As a non-limiting example, the coating 110 can include multiple different grades of nylon having varied mechanical properties. Alternatively, the coating 110 can be a combination of nylon and urethane, or any other combination of materials as would be suitable for the particular application.

The shape or pattern of the coating 110 on the groove 108 can also be varied with, for example, a textured coating 110 or by alternating coating 110 materials to provide additional traction or engagement to the cable as it is passed over the wheel 102. For example, the coating can include multiple bands positioned transverse across the groove 108 with each band alternating between different materials (e.g., alternating each band between a polymer material and a ceramic material). The pattern of the coating 110 can also be designed to dissipate heat from the wheel 102 while in use. For example, the coating 110 can include gaps between adjacent portions of coating 110 to allow air to pass between portions of the coating 110 to provide a cooling effect to the wheel 102. Alternatively, or in addition, the coating 110 can be made entirely or partially from material known to prevent heat transfer to reduce heat transfer between the cable and the wheel 102 and vice versa.

The coating 110 can also be applied to the entire surface of the wheel 102 (e.g., the exterior of the wheel in addition to the groove 108) to protect the wheel 102 from corrosive environments. The wheel 102, for example, can be coated with a material intended to protect the additive-coated sheave 100 from rain and sun exposure while in use on power poles. The wheel 102 can also be coated with a polymer coating 110 intended to protect the additive-coated sheave 100 from a harsh chemical environment experienced in a manufacturing plant. The wheel 102 could also be coated with a ceramic material intended to protect the additive-coated sheave 100 from high temperatures. Alternatively, or in addition, the center bore 104 can be coated in a low friction coating to allow the additive-coated sheave 100 to rotate with reduced friction. The low-friction coating can be applied to the center bore 104 in place of, or in addition to, the bearing 106 and/or bushing. These examples are given merely for illustrative purposes and a person of skill in the art will understand that many different types of coatings could be used for many different applications.

As discussed previously, the present disclosure relates to an improved additive-coated sheave 100 that has a coating 110 applied to the wheel 102 by additive manufacturing. The coating 110 can be applied directly to any surface of the wheel 102, but particularly in the groove 108, using additive manufacturing processes such as a spray-on liner or repeatedly dipping the wheel 102 in a material and allowing the material to at least partially harden between each dip until the wheel 102 is coated with multiple layers of the coating 110. To help ensure the shape or profile of the groove 108 is properly formed, a tool such as a roller, a scraper, a form, or other tool that is capable of forming the groove 108 can be used while the coating 110 is applied. For example, the wheel 102 can be held in a fixture and allowed to spin while a coating 110 is applied using a spray gun or by dipping the wheel in the coating 110. While the wheel 102 is spun and the coating 110 is added, a tool (such as a roller) can be used to form the profile of the groove 108. The coating 110 can also be applied using more complex additive manufacturing processes such as photopolymerization, powder bed fusion, binder jetting, material extrusion, material jetting, ultrasonic additive manufacturing, laminated object manufacturing, directed energy deposition, electron beam melting, or any other suitable form of additive manufacturing. In some examples, the coating can be applied by repeatedly adding layers onto the surface of the wheel 102 and/or the groove 108 until an appropriate depth of coating 110 is achieved. In any of the illustrative manufacturing processes discussed herein, it will be appreciated that such manufacturing processes can be performed manually, semi-automatically, or fully-automatically to manufacture the additive-coated sheave 100 depending on the particular application.

In some examples, the strength of the bonding interface between the coating 110 and the wheel 102 can be improved by pre-treating the groove 108. The groove 108 can be, for example, blasted with media, coated with a primer, sanded, or treated with processes such as heat, corona, or plasma treatment. Alternatively, the groove 108 can be manufactured to allow the coating 110 to bond to the surface. This can include cutting or etching depressions, lines, grids, or other features into the groove 108. Furthermore, adhesives can be used, either alone or in combination with these surface treatments, to ensure the coating 110 bonds with the groove 108. In any of these examples, the overall durability of the additive-coated sheave 100 can be improved over prior art sheaves because the coating 110 can better remain adhered to the surface of the wheel 102.

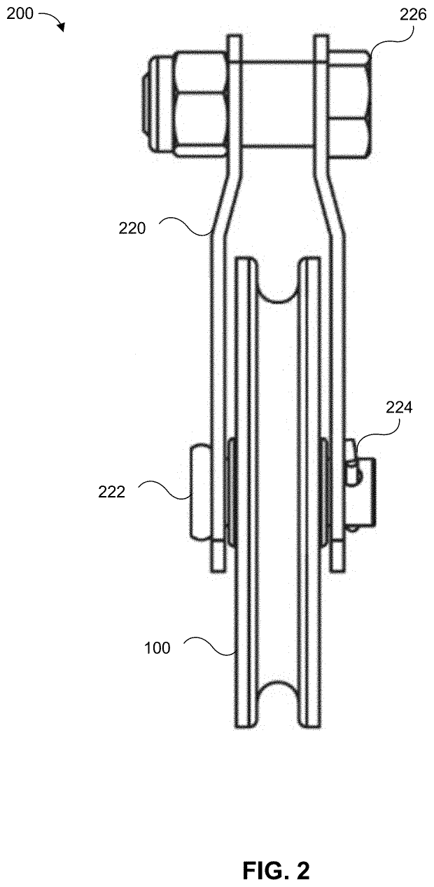

FIG. 2 illustrates an additive-coated sheave assembly 200 in accordance with the disclosed technology. As illustrated, the additive-coated sheave assembly 200 can include an additive coated sheave 100 that can include any of the features or be manufactured using any of the manufacturing processes described herein. The additive-coated sheave 100 can be attached to a frame 220 that can be configured to receive and support the additive-coated sheave 100. The frame 220 can be sized and shaped for the particular application. For example, as illustrated in FIG. 2, the frame 220 can include two sides that can extend along the sides of the additive-coated sheave 100. As will be appreciated by one of skill in the art, however, the frame 220 illustrated in FIG. 2 is offered for illustrative purposes and the frame 220 can comprise other shapes and configurations such that the additive-coated sheave 100 can be used in various applications.

The additive-coated sheave assembly 200 can include an axle 222 to support the additive-coated sheave 100 and attach the additive-coated sheave 100 to the frame 220. As will be appreciated by one of skill in the art, the additive-coated sheave 100 can be configured to rotate around the axle 222. If the additive-coated sheave 100 comprises bearings 106 or bushings, the bearings 106 or bushings can be installed between the additive-coated sheave 100 and the axle 222. In some examples, a pin 224 such as a cotter pin or other similar securing mechanism can be connected to the axle 222 to retain the axle 222 in place and to allow the axle 222 to be removed. This can be useful, for example, if the additive-coated sheave 100 needs to be replaced with another additive-coated sheave 100 that is a different size or comprises different features, or if the additive-coated sheave 100 is worn and must be replaced.

The additive-coated sheave assembly 200 can include an attachment mechanism 226 that can be configured to facilitate attachment of the additive-coated sheave assembly 200 to various objects. For example, the attachment mechanism 226 can be configured to facilitate attachment of the additive-coated sheave assembly 200 to a utility pole, to machinery, to various support framing assemblies, to a vehicle, to a boat, or to any other object as would be suitable for the application. Furthermore, although depicted as a simple bolt and nut assembly, the attachment mechanism 226 can comprise any type of attachment mechanism 226 for the application. For example, the attachment mechanism 226 can be a custom-made attachment mechanism for the specific application where the additive-coated sheave assembly 200 will be used.

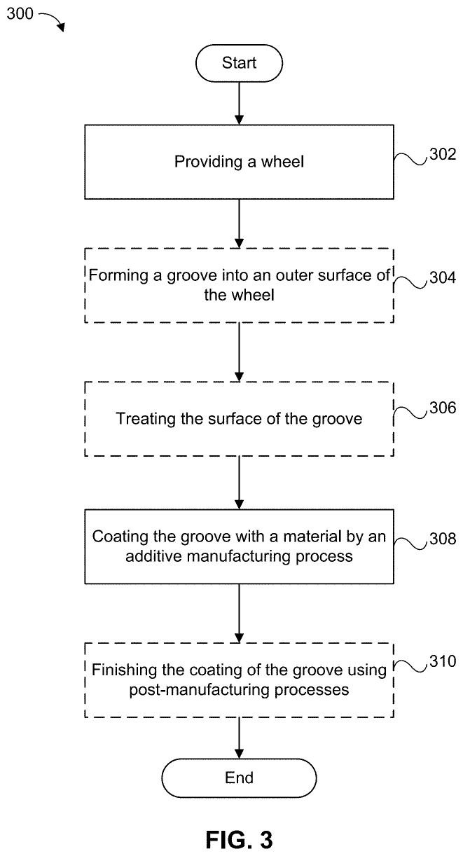

FIG. 3 is a flowchart depicting an example of a method 300 for manufacturing an additive-coated sheave 100, in accordance with some examples of the present disclosure. The method 300 can include, providing 302 a wheel, forming 304 a groove 108 into an outer circumferential surface of the wheel 102, treating 306 the surface of the groove 108, coating 308 the groove 108 with a material by an additive manufacturing process, and finishing 310 the coating of the groove 108 using post-manufacturing processes.

Forming 304 a groove 108 into an outer circumferential surface of a wheel 102 can include cutting, routing, cold-forming, stamping, welding, sanding, machining, or any other suitable manufacturing process to form a groove 108 into an outer circumferential surface of a wheel 102. Treating 306 the surface of the groove 108 can include any of the above-described processes to help ensure the coating 110 will adhere to the groove 108. Treating 306 the surface of the groove 108 can include, but is not limited to: blasting the surface of the groove 108 with media, coating the surface of the groove 108 with a primer, sanding the surface of the groove 108, treating the surface of the groove 108 with processes such as heat, corona, or plasma treatment, cutting or etching depressions, lines, grids, or other features into the groove 108, and/or applying adhesives or other chemical compositions to the surface of the groove 108.

Coating 308 the groove 108 by an additive manufacturing process could include any of the previously-mentioned methods of additive manufacturing, including: photopolymerization, powder bed fusion, binder jetting, material extrusion, material jetting, ultrasonic additive manufacturing, laminated object manufacturing, directed energy deposition, electron beam melting, or any other suitable form of additive manufacturing. Furthermore, as described previously, a tool such as a roller, a scraper, a form, or other tool that is capable of forming the groove 108 can be used while the coating 110 is applied to help ensure the shape or profile of the groove 108 is properly formed. Finishing 310 the coating of the groove 108 using post-manufacturing processes can include milling, routing, machining, heat treatment, Ultra-violet light treatment, curing, cleaning, de-powdering, coating, infiltration, sanding, sand blasting, shot peening, dying, painting, or any other suitable post-manufacturing process. As will be appreciated, finishing 310 can include any post-manufacturing process for ensuring the additive-coated sheave 100 comprises a desired look, finish, strength characteristics, and meets requires manufacturing tolerances.

As previously described, many different additive manufacturing processes could be used to apply the coating 110 to the groove 108. To illustrate, the method could include, forming 304 a groove 108 into an outer surface of an aluminum wheel, treating 306 the surface of the groove 108 by sanding it, and then coating 308 the groove 108 by repeatedly dipping the wheel 102 into a molten material or other solution. The method could also include forming 304 a groove 108 into an outer surface of a nylon wheel 102, treating 306 the surface of the groove 108 with a plasma treatment, and then coating 308 the groove 108 by repeatedly spraying a material onto the groove 108. The method could also include forming 304 a groove 108 into an outer surface of a stainless-steel wheel 102, treating 306 the surface of the groove 108 by etching depressions into the surface, and then coating 308 the groove 108 by using material extrusion to apply a material onto the groove 108.

One of skill in the art will appreciate that, depending on the application, some of the steps of the method 300 can be omitted. For example, the step of forming 304 a groove into an outer surface of the wheel 102 can be omitted if the groove 108 is formed at the same time as the wheel 102 is formed. The groove 108 can be formed into the wheel 102, for example, during a cast process that does not require post-manufacturing processing. The method 300 can also be modified to omit the step of treating 306 the surface of the groove 108 if treatment is not necessary to adhere the coating 110 to the groove 108. As will be appreciated, the method 300 is offered merely for illustrative purposes and one of skill in the art will understand that the method 300 can be modified using many of the variations previously described to manufacture an additive-coated sheave 100.

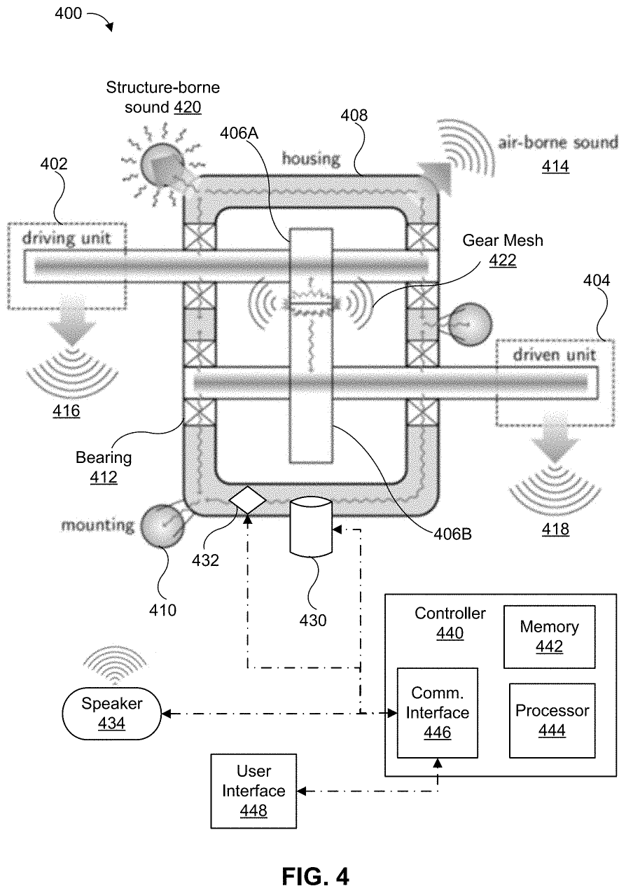

As described herein, the coating 110 can provide an additional benefit of reducing the overall sound produced by the additive-coated sheave 100 when in use. The disclosed technology can further include a system 400 for reducing sound and vibrations produced by equipment. The system 400 can be used in conjunction with the additive-coated sheave 100 or deployed on equipment separate from the additive-coated sheave 100. FIG. 4, illustrates an example system 400 for reducing sound and vibrations produced by equipment and various components of the equipment. As will be appreciated by one of skill in the art, equipment that is operated by various motive forces such as a combustion engine, an electrical motor, a hydraulic system, a pneumatic system, and other various motive forces can generate a considerable amount of sound and vibrations. The sound and vibrations produced by the equipment can reduce an operator's enjoyment of operating the equipment, cause adverse health effects, and can create a dangerous situation due to the operator being unable to hear potentially dangerous conditions near the equipment. What is needed, therefore, is a system and method of reducing the overall sound and vibrations generated by the equipment.

As illustrated in FIG. 4, and as will be appreciated by one of skill in the art, a typical example equipment that can generate sound and vibrations when in operation can include a driving unit 402 (e.g., a combustion engine, an electrical motor, a hydraulic system, a pneumatic system, etc.), a driven unit 404 (e.g., a component of the machinery that is to be operated), a driving gear 406A and a driven gear 406B, and a housing 408. The housing 408 can be configured to house and retain the driving gear 406A and the driven gear 406B in a position wherein the driving gear 406A can contact the driven gear 406B to transfer energy from the driving unit 402 to the driven unit 404. The housing 408 can be further mounted to a mounting 410 such as a chassis of mobile equipment or a frame of stationary equipment. The housing 408 can further include one or more bearings 412 to help reduce friction that may be present between an interface of the driving unit 402 and the housing 408 and an interface of the driven unit 404 and the housing 408.

As will be appreciated by one of skill in the art, when the driving unit 402 is operated and transfers energy to the driven unit 404 via the driving gear 406A and the driven gear 406B, the resultant forces present can cause vibrations in the equipment which, in turn, can cause sound generated by the oscillating equipment. This can be especially true in rotating equipment. For example, when the housing 408 vibrates, air-borne sound 414 can be generated by the oscillation of the housing 408. Furthermore, driving unit sound 416, driven unit sound 418, structure-borne sound 420, and sound at the gear mesh 422 can all be generated as energy is transferred through the system 400 and the various equipment vibrates or oscillates.

To help reduce the overall noise generated by the equipment, the system 400 can include a vibration inducer 430 that can be configured to induce vibrations into the equipment that can reduce or altogether cancel the vibrations in the system 400 that produce noise. The vibration inducer 430, for example, can be a mass driver that is installed at a predetermined location (such as a node point or anti-node point) that can induce a vibration into the system 400 to counteract the sound waves and vibrations produced by the various sources of vibration and sound described herein. The vibration inducer 430, as other non-limiting examples, can be or include a system having an electric motor and being configured to rotate, slide, swing, or otherwise move a counterweight to induce vibrations into the equipment. Similarly, the vibration inducer 430 can be a hydraulic, pneumatic, combustion, or other motive system that can be configured to rotate, slide, swing, or otherwise move a counterweight to induce vibrations. No matter the configuration, the vibration inducer 430 can be configured to induce vibrations into the equipment to counteract the soundwaves and vibrations produced by the various vibration sources. In other words, the vibration inducer 430 can be configured to emit vibrations within the system 400 of the same amplitude but with an inverted phase (antiphase) to the original vibration source. As the vibrations from the vibration source and the vibration inducer 430 combine, the vibrations can effectively cancel each other out, or at least partially cancel each other out, through destructive interference of the vibration waves reducing the overall sound and vibration produced by the system 400. Furthermore, although only a single vibration inducer 430 is illustrated in FIG. 4, one of skill in the art will appreciate that the system 400 can include more than one vibration inducer 430 with each vibration inducer 430 being installed at a predetermined location to reduce the overall sound and vibration produced by the system 400.

The system 400 can include a sensor 432 that can be configured to detect the presence and characteristics of vibrations (e.g., a frequency, an amplitude, a wavelength, time period, a velocity, and/or a location of a vibration) in the system 400. The sensor 432 can be a part of the vibration inducer 430 or the sensor 432 can be separate from the vibration inducer 430. The sensor 432 can be an accelerometer, a vibration meter, a vibration data logger, a velocity sensor, a proximity probe, a laser displacement sensor, a strain gauge, a gyroscope, a pressure sensor, a microphone, or any other suitable sensor 432 for the application. Furthermore, although only a single sensor 432 is illustrated in FIG. 4, one of skill in the art will appreciate that the system 400 can include more than one sensor 432 with each sensor 432 being installed at a predetermined location to detect the characteristics of vibrations present at various locations in the system 400.

The system 400 can include one or more speakers 434 that can be configured to output sound to produce sound cancellation of sound waves on or near the equipment. For example, the speaker can be configured to output a sound wave that reduce or cancel sound waves produced by the equipment. The speaker 434 (or multiple speakers 434) can be positioned such that the sound waves produced by the equipment are canceled out or reduced near a point where an operator is likely to be positioned (e.g., in a cab or operating station of the equipment).

The system 400 can further include a controller 440 that can be configured to receive vibration data from the sensor 432 (or multiple sensors 432), determine a suitable output of the vibration inducer 430, and output a signal to the vibration inducer 430 and/or speaker 434 to cause the vibration inducer 430 and/or speaker 434 to oscillate at a suitable frequency and amplitude. For example, the controller 440 can receive a signal from the sensor 432 (or multiple sensors 432) that can be indicative of a characteristic of a vibration or sound wave (e.g., a frequency, an amplitude, a wavelength, a time period, a velocity, and/or a location of a vibration) detected in, on, or near the equipment. The controller 440 can then determine, based at least in part on the vibration data, how the vibration inducer 430 (or multiple vibration inducers 430) and/or speaker 434 (or multiple speakers 434) should be operated to reduce the overall sound and vibration of the system 400. For example, the controller 440 can determine a frequency and amplitude at which the vibration inducer 430 and or speaker 434 should be operated to achieve a desired sound reduction of the system 400. Furthermore, the controller 440 can determine, based at least in part on the vibration data, whether more than one vibration inducer 430 and/or one or more speakers 434 should be operated and at what frequency and amplitude each vibration inducer 430 and each speaker 434 should be operated.

The controller 440 can include a memory 442, a processor 444, and a communication interface 446. The controller 440 can be a computing device configured to receive data, determine actions based on the received data, and output a control signal to the display/user interface 448. One of skill in the art will appreciate that the controller 440 can be installed in any location, provided the controller 440 is in communication with the sensor 432 and the vibration inducer 430. Furthermore, the controller 440 can be configured to send and receive wireless or wired signals and the signals can be analog or digital signals. The wireless signals can include Bluetooth™, BLE, WiFi™, ZigBee™, infrared, microwave radio, or any other type of wireless communication as may be suitable for the particular application. The hard-wired signal can include any directly wired connection between the controller and the other components described herein. Alternatively, the components can be powered directly from a power source and receive control instructions from the controller 440 via a digital connection. The digital connection can include a connection such as an Ethernet or a serial connection and can utilize Modbus, fieldbus, PROFIBUS, SafetyBus p, Ethernet/IP, or any other suitable communication protocol for the application. Furthermore, the controller 440 can utilize a combination of wireless, hard-wired, and analog or digital communication signals to communicate with and control the various components. One of skill in the art will appreciate that the above configurations are given merely as non-limiting examples and the actual configuration can vary depending on the particular application.

The controller 440 can include a memory 442 that can store a program and/or instructions associated with the functions and methods described herein and can include one or more processors 444 configured to execute the program and/or instructions. The memory 442 can include one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory.

The controller 440 can also have a communication interface 446 for sending and receiving communication signals between the various components. Communication interface 446 can include hardware, firmware, and/or software that allows the processor(s) 444 to communicate with the other components via wired or wireless networks, whether local or wide area, private or public, as known in the art. Communication interface 446 can also provide access to a cellular network, the Internet, a local area network, or another wide-area network as suitable for the particular application. By accessing a cellular network, the Internet, a local area network, or another wide-area network, the controller 440 can be configured to receive periodic updates and/or to download additional control modules that can help ensure the system 400 operates correctly and efficiently.

Additionally, the controller 440 can have or be in communication with a display/user interface 448 for displaying game information and receiving inputs from a player of the game. The display/user interface 448 can be installed locally or be a remotely controlled device such as a mobile device. The operator of the equipment, for example, can view system data on the display/user interface 448 and input data or commands to the controller 440 via the display/user interface 448. For example, the operator, for example and input date or commands to change an output or operation of the vibration inducer 430 change the sound output by the system 400 or to turn off the vibration inducer 430 altogether. As a non-limiting example, the display/user interface 448 can be a screen mounted on the system 400 that has one or more buttons and/or a touch screen configured to receive input from the player. As another non-limiting example, the display/user interface 448 can be an operator's mobile device and an application can be downloaded to the mobile device to facilitate communication with the communication interface 446, display system 400 information, and receive input data from the operator.

While the present disclosure has been described in connection with a plurality of example aspects, as illustrated in the various figures and discussed above, it is understood that other similar aspects can be used, or modifications and additions can be made to the described subject matter for performing the same function of the present disclosure without deviating therefrom. In this disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims. Moreover, various aspects of the disclosed technology have been described herein as relating to methods, systems, mechanism, mechanisms, and/or non-transitory, computer-readable medium storing instructions. However, it is to be understood that the disclosed technology is not necessarily limited to the examples and embodiments expressly described herein. That is, certain aspects of a described system can be included in the methods described herein, aspects of a described mechanism or system can be included in another mechanism or system, various aspects of a described method can be included in a system described herein, and the like.

1. An additive-coated sheave comprising:
a wheel having a groove in an outer circumferential surface of the wheel; and
a coating affixed to the groove by an additive manufacturing process;
wherein one or more of:
the wheel comprises two or more materials;
the groove is cut or forged into the outer circumferential surface of the wheel;
the groove is heat treated before the coating is affixed to the groove;
the groove is pretreated before the coating is affixed to the groove, wherein the pretreatment is selected from the group consisting of a corona treatment and a plasma treatment;
an adhesive is used to affix the coating to the groove;
the coating comprises a monomer material;
the coating comprises two or more materials affixed to the groove in alternating transverse bands;
one or more depressions are formed into the groove before the coating is affixed to the groove; and/or
the additive manufacturing process is selected from the group consisting of ultrasonic additive manufacturing, directed energy deposition, electron beam melting, and combinations thereof.

2. The additive-coated sheave according to claim 1, wherein the additive manufacturing process is selected from the group consisting of repeatedly spraying the coating onto the groove, repeatedly dipping the wheel into a molten material and allowing the material to harden between each dip, photopolymerization, powder bed fusion, binder jetting, material extrusion, and combinations thereof; and
wherein one or more of:
the wheel comprises two or more materials;
the groove is cut or forged into the outer circumferential surface of the wheel;
the groove is heat treated before the coating is affixed to the groove;
the groove is pretreated before the coating is affixed to the groove, wherein the pretreatment is selected from the group consisting of a corona treatment and a plasma treatment;
an adhesive is used to affix the coating to the groove;
the coating comprises a monomer material;
the coating comprises two or more materials affixed to the groove in alternating transverse bands; and/or
one or more depressions are formed into the groove before the coating is affixed to the groove.

3-10. (canceled)

11. The additive-coated sheave according to claim 1, wherein the groove is:
pretreated with a primer before the coating is affixed to the groove; or
sanded before the coating is affixed to the groove.

12-16. (canceled)

17. The additive-coated sheave according to claim 1, wherein one or more ridges are formed into the groove before the coating is affixed to the groove.

18-19. (canceled)

20. The additive-coated sheave of claim 1, wherein the coating comprises a material selected from the group consisting of a polymer material, a composite material, a metal, a ceramic material, and combinations thereof; and
wherein one or more of:
the wheel comprises two or more materials;
the groove is cut or forged into the outer circumferential surface of the wheel;
the groove is heat treated before the coating is affixed to the groove;
the groove is pretreated before the coating is affixed to the groove, wherein the pretreatment is selected from the group consisting of a corona treatment and a plasma treatment;
an adhesive is used to affix the coating to the groove;
the coating comprises two or more materials affixed to the groove in alternating transverse bands;
one or more depressions are formed into the groove before the coating is affixed to the groove; and/or
the additive manufacturing process is selected from the group consisting of ultrasonic additive manufacturing, directed energy deposition, electron beam melting, and combinations thereof.

21-23. (canceled)

24. The additive-coated sheave of claim 1, wherein the coating has a surface selected from the group consisting of a smooth exterior surface, a textured exterior surface, ridges in the surface, and combinations thereof.

25-26. (canceled)

27. The additive-coated sheave of claim 1, wherein the coating comprises a material that is harder than a material forming the wheel.

28. The additive-coated sheave of claim 1, wherein the coating comprises a material that is softer than a material forming the wheel.

29. (canceled)

30. The additive-coated sheave of Claim 1 further comprises comprising:
an axle configured to support the wheel;
a frame configured to receive and support the axle; and
a bearing positioned between the wheel and the axle.

31. The additive-coated sheave of Claim 1 further comprising:
an axle configured to support the wheel;
a frame configured to receive and support the axle; and
a bushing positioned between the wheel and the axle.

32-33. (canceled)

34. The additive-coated sheave of claim 1, wherein the wheel comprises a single continuous material.

35. An additive-coated sheave assembly comprising:
a wheel wheel comprising:
a hub;
a plurality of spokes affixed to the hub; and
a rim;
wherein an outer circumferential surface of the rim comprises a groove; and
a coating affixed to the groove by an additive manufacturing process.

36. (canceled)

37. A method of manufacturing an additive-coated sheave comprising:
forming a groove into an outer circumferential surface of a wheel; and
coating the groove with a material by an additive manufacturing process;
wherein one or more of:
the additive manufacturing process comprises photopolymerization;
the additive manufacturing process comprises powder bed fusion;
the additive manufacturing process comprises binder jetting;
the additive manufacturing process comprises material extrusion;
the additive manufacturing process comprises ultrasonic additive manufacturing;
the additive manufacturing process comprises directed energy deposition;
the additive manufacturing process comprises electron beam melting;
the coating comprises a monomer material;
the coating comprises two or more materials affixed to the groove in alternating transverse bands;
the groove is forged into the outer circumferential surface of the wheel; and/or
the groove is cut into the outer circumferential surface of the wheel.

38. The method of claim 37, wherein the additive manufacturing process comprises repeatedly spraying the coating onto the groove; and
wherein one or more of:
the coating comprises a monomer material;
the coating comprises two or more materials affixed to the groove in alternating transverse bands;
the groove is forged into the outer circumferential surface of the wheel; and/or
the groove is cut into the outer circumferential surface of the wheel.

39. The method of claim 37, wherein the additive manufacturing process comprises repeatedly dipping the wheel into a molten material and allowing the material to harden between each dip; and
wherein one or more of:
the coating comprises a monomer material;
the coating comprises two or more materials affixed to the groove in alternating transverse bands;
the groove is forged into the outer circumferential surface of the wheel; and/or
the groove is cut into the outer circumferential surface of the wheel.

40-47. (canceled)

48. The method of claim 37, wherein the coating comprises a material selected from the group consisting of a polymer material, a composite material, a metal, a ceramic material, and combinations thereof; and
wherein one or more of:
the additive manufacturing process comprises photopolymerization;
the additive manufacturing process comprises powder bed fusion;
the additive manufacturing process comprises binder jetting;
the additive manufacturing process comprises material extrusion;
the additive manufacturing process comprises ultrasonic additive manufacturing;
the additive manufacturing process comprises directed energy deposition;
the additive manufacturing process comprises electron beam melting;
the coating comprises two or more materials affixed to the groove in alternating transverse bands;
the groove is forged into the outer circumferential surface of the wheel;
the groove is cut into the outer circumferential surface of the wheel; and/or
the coating has a surface selected from the group consisting of a smooth exterior surface, a textured exterior surface, ridges in the surface, and combinations thereof.

49-60. (canceled)

61. The method of claim 37, wherein the wheel comprises:
a hub;
a plurality of spokes affixed to the hub; and
a rim, wherein an outer circumferential surface of the rim comprises the groove.

62. The method of claim 37, wherein the wheel comprises a two or more materials.

63. The method of claim 37 further comprising:
treating an outer surface of the groove prior to coating the groove with the material by the additive manufacturing process.

64. The method of claim 63, wherein treating the outer surface of the groove is selected from the group consisting of pretreating the outer surface of the groove with a primer, sanding the outer surface of the groove, heat treating the outer surface of the groove, pretreating the outer surface of the groove with a corona treatment, pretreating the outer surface of the groove with a plasma treatment, forming one or more depressions into the outer surface of the groove, forming one or more ridges on the outer surface of the groove, applying an adhesive to the outer surface of the groove, and combinations thereof.

65-71. (canceled)

72. The method of claim 37 further comprising:
finishing the coating of the groove using a post-manufacturing process.

73. The method of claim 72, wherein the post-manufacturing process is selected from the group consisting of machining the groove, routing the groove, applying a heat treatment to the coating, applying an ultra-violet treatment to the coating, curing the coating, cleaning the coating, de-powdering the coating, sanding the coating, sand blasting the coating, shot peening the coating, dying the coating, painting the coating, and combinations thereof.

74-84. (canceled)

85. A method of manufacturing an additive-coated sheave comprising:
treating a groove in an outer circumferential surface of a wheel; and
coating the groove with a material by an additive manufacturing process;
wherein:
when the wheel is an aluminum wheel, treating the groove comprises sanding the groove, and the additive manufacturing process comprises repeatedly dipping the additive-coated sheave into a molten material and allowing the molten material to harden between each dip of the additive-coated sheave into the molten material;
when the wheel is a nylon wheel, treating the groove comprises treating the groove with a plasma treatment, and the additive manufacturing process comprises repeatedly spraying a liquid material onto the additive-coated sheave and allowing the liquid material to harden between each spray of the liquid material onto the additive-coated sheave; and
when the wheel is a stainless steel wheel, treating the groove comprises treating the groove by etching depressions into an outer surface of the groove, and the additive manufacturing process comprises material extrusion.

86-87. (canceled)
